(19) United States
(12) Patent Application Publication
(10) Pub. No.: US 2017/0335999 A1
(43) Pub. Date: Nov. 23, 2017

(54) POLYAMIDE RESIN COMPOSITION FOR MOLDED ARTICLE EXPOSED TO HIGH-PRESSURE HYDROGEN AND MOLDED ARTICLE MADE OF THE SAME

(71) Applicant: Toray Industries, Inc., Tokyo (JP)

(72) Inventors: Shinichiro Ochiai, Nagoya (JP); Daisuke Sato, Ichihara (JP); Sadayuki Kobayashi, Nagoya (JP)

(21) Appl. No.: 15/526,822

(22) PCT Filed: Oct. 26, 2015
(86) PCT No.: PCT/JP2015/080094

§ 371 Date: May 15, 2017

(30) Foreign Application Priority Data
Nov. 20, 2014 (JP) 2014-235139

(51) Int. Cl. F16L 11/10; C08L 77/06; F16L 57/06; H01M 8/04

(52) U.S. Cl. CPC F16L 11/10; H01M 8/04; C08L 77/06; F16L 57/06; C08L 2205/06

(57) ABSTRACT

A polyamide resin composition for a molded article exposed to high-pressure hydrogen contains a polyamide resin (A) including a unit derived from hexamethylenediamine and a unit derived from an aliphatic dicarboxylic acid of 8 to 12 carbon atoms and an ethylene/α-olefin copolymer (B) modified with an unsaturated carboxylic acid and/or a derivative thereof. The polyamide resin composition provides a molded article having excellent flexibility and heat cycle resistance and less likely to suffer failure points despite repeated charging and discharging of high-pressure hydrogen.

### TECHNICAL FIELD

This disclosure relates to a polyamide resin composition for a molded article exposed to high-pressure hydrogen and to a molded article made of the composition.

### BACKGROUND

Fuel-cell electric vehicles equipped with fuel cells that generate electricity by electrochemical reaction of hydrogen with oxygen in the air, the electricity generated by the fuel cells being supplied to motors and used as driving force, have recently been receiving attention as countermeasures against the depletion of petroleum fuel and the demand for reductions in toxic gas emissions. Conventional resin tanks and hoses disadvantageously undergo deformation or breakage with repeated charging and discharging of high-pressure hydrogen. This is because hydrogen, for its small molecular size, readily permeates through the resins as compared, for example, to natural gas, which has a relatively large molecular size, and high-pressure hydrogen, as compared to hydrogen at atmospheric pressure, may be accumulated in the resins in larger amounts.

For example, a tank comprising a metallic end component, a polyamide resin liner surrounding the end component, and a layer for a structure of a fiber impregnated with a thermosetting resin that surrounds the liner is disclosed as a tank for storage of a gas such as hydrogen that is mounted on a fuel-cell electric vehicle (see JP 2011-505523 A, for example). For example, a hydrogen tank liner made of a hydrogen tank liner material comprising a polyamide resin composition containing a polyamide 6, a copolyamide, and an impact modifier is disclosed as a hydrogen tank liner having excellent gas barrier properties and high impact resistance at low temperatures (see JP 2009-191871 A, for example).

In addition, a hose for charging hydrogen comprising an inner layer made of nylon, polyacetal, ethylene-vinylalcohol copolymer, or the like is disclosed as a hose for charging a fuel-cell vehicle or the like with hydrogen from a hydrogen station (see JP 2010-031993 A, for example).

On the other hand, the tank disclosed in JP 2011-505523 A has insufficient heat cycle resistance because, when it is subject to repeated temperature changes (heat cycles) from −40° C. or lower to 90° C. or higher due to charging and discharging of high-pressure hydrogen, cracks tend to occur at the joint between the resin portion and the metal portion. The hydrogen tank liner disclosed in JP 2009-191871 A, although improved somewhat in heat cycle resistance, still has insufficient heat cycle resistance. The resin composition disclosed in JP 2009-191871 A has disadvantages in that permeation of hydrogen gas and absorption of hydrogen into the resin are likely to occur due to low crystalline property of the polyamide resin, and the hydrogen tank liner suffers failure points with repeated charging and discharging of high-pressure hydrogen.

The hose for charging hydrogen disclosed in JP 2010-031993 A is described as a hose comprising an inner layer made of a nylon resin having a dry hydrogen gas permeation coefficient of 1×10⁻⁸ cc·cm/cm²·sec.·cmHg or less at the temperature of 90° C. However, there is no detailed description of what specifically the nylon resin is. Furthermore, common nylon resins were regarded as having insufficient flexibility and heat cycle resistance to use for a hose for charging hydrogen.

It could therefore be helpful to provide a polyamide resin composition that can provide a molded article having excellent flexibility and heat cycle resistance and less likely to suffer failure points despite repeated charging and discharging of high-pressure hydrogen.

### SUMMARY

We thus provide:

A polyamide resin composition for a molded article exposed to high-pressure hydrogen, the composition comprising a polyamide resin (A) including a unit derived from hexamethylenediamine and a unit derived from an aliphatic dicarboxylic acid of 8 to 12 carbon atoms and an ethylene/α-olefin copolymer (B) modified with an unsaturated carboxylic acid and/or a derivative thereof.

A molded article exposed to high-pressure hydrogen, the article comprising the above-described polyamide resin composition.

A hose for high-pressure hydrogen exposed to high-pressure hydrogen, the hose comprising the above-described polyamide resin composition.

A hose for high-pressure hydrogen, the hose comprising a reinforcement layer on the outside of an inner layer comprising the above-described polyamide resin composition.

The polyamide resin composition for a molded article exposed to high-pressure hydrogen can provide a molded article having excellent flexibility and heat cycle resistance and less likely to suffer failure points despite repeated charging and discharging of high-pressure hydrogen. The molded article, for its excellent flexibility and heat cycle resistance and unlikeliness to suffer failure points despite repeated charging and discharging of high-pressure hydrogen, can be advantageously used as a molded article used in applications exposed to high-pressure hydrogen.

### BRIEF DESCRIPTION OF THE DRAWING

FIG. 1 is a cross section view of a preferred aspect of the hose for high-pressure hydrogen.

### DESCRIPTION OF SYMBOLS

1: Inner layer

2: Reinforcement layer

3: Weather-resistant layer

### DETAILED DESCRIPTION

Our compositions and molded articles will now be described in more detail.

The polyamide resin composition for a molded article exposed to high-pressure hydrogen (hereinafter referred to as “the polyamide resin composition”) comprises at least a polyamide resin (A) including a unit derived from hexamethylenediamine and a unit derived from an aliphatic dicarboxylic acid of 8 to 12 carbon atoms (hereinafter referred to as “the polyamide resin (A)”) and an ethylene/α-olefin copolymer (B) modified with an unsaturated carboxylic acid and/or a derivative thereof (hereinafter referred to as “the ethylene/α-olefin copolymer (B)”). The polyamide resin (A) including a unit derived from hexamethylenediamine and a unit derived from an aliphatic dicarboxylic acid of 8 to 12 carbon atoms has excellent moldability and gas barrier property. The polyamide resin (A) also has excellent flexibility. This can relax strain of a molded article due to temperature changes, and thus the polyamide resin (A) has excellent heat cycle resistance. Furthermore, since the polyamide resin (A) has high crystallinity, it can reduce permeation of hydrogen gas and absorption of hydrogen into the resin, and thus can provide a molded article in which failure points are unlikely to occur despite repeated charging and discharging of high-pressure hydrogen. Combining the polyamide resin (A) with the ethylene/α-olefin copolymer (B) modified with an unsaturated carboxylic acid and/or a derivative thereof can improve the flexibility and heat cycle resistance. Molded articles used in applications exposed to high-pressure hydrogen are subject to repeated temperature changes (heat cycles) from −40° C. or lower to 90° C. or higher due to charging and discharging of high-pressure hydrogen. Thus, for example, when a molded article is a composite article having a resin portion and a metal portion, cracks tend to occur at the joint between the resin portion and the metal portion. Adding the ethylene/α-olefin copolymer (B) modified with an unsaturated carboxylic acid and/or a derivative thereof can prevent such cracks that may occur at the joint between the resin portion and the metal portion due to repeated heat cycles.

The polyamide resin (A) is a polyamide resin composed mainly of a unit derived from hexamethylenediamine and a unit derived from an aliphatic dicarboxylic acid of 8 to 12 carbon atoms. Other monomers may be copolymerized to the extent that the desired effect is not adversely affected. “Composed mainly of” means that the unit derived from hexamethylenediamine and the unit derived from an aliphatic dicarboxylic acid of 8 to 12 carbon atoms are contained in a total amount of 50 mol % or more based on 100 mol % of total monomer units constituting the polyamide resin. The unit derived from hexamethylenediamine and the unit derived from an aliphatic dicarboxylic acid of 8 to 12 carbon atoms are more preferably contained in an amount of 70 mol % or more, still more preferably 90 mol % or more.

Examples of an aliphatic dicarboxylic acid of 8 to 12 carbon atoms include sebacic acid, suberic acid, azelaic acid, undecanedioic acid, and dodecanedioic acid. Two or more of these may be used. Of these, sebacic acid or dodecanedioic acid, which can provide a polyamide resin composition having an excellent balance of crystalline property and strength, are preferred, and sebacic acid is particularly preferred.

Other examples of the monomers to be copolymerized include amino acids such as 6-aminocaproic acid, 11-aminoundecanoic acid, 12-aminododecanoic acid, and p-aminomethylbenzoic acid; lactams such as ε-caprolactam and ω-laurolactam; aliphatic diamines such as tetramethylenediamine, pentamethylenediamine, 2-methylpentamethylenediamine, undecamethylenediamine, dodecamethylenediamine, 2,2,4-/2,4,4-trimethylhexamethylenediamine, and 5-methylnonamethylenediamine; aromatic diamines such as m-xylenediamine and p-xylylenediamine; alicyclic diamines such as 1,3-bis(aminomethyl) cyclohexane, 1,4-bis(aminomethyl) cyclohexane, 1-amino-3-aminomethyl-3,5,5-trimethylcyclohexane, bis(4-aminocyclohexyl) methane, bis(3-methyl-4-aminocyclohexyl) methane, 2,2-bis(4-aminocyclohexyl) propane, bis(aminopropyl) piperazine, and aminoethylpiperazine; aliphatic dicarboxylic acids such as adipic acid, malonic acid, succinic acid, glutaric acid, pimelic acid, tetradecanedioic acid, pentadecanedioic acid, and octadecanedioic acid; aromatic dicarboxylic acids such as terephthalic acid, isophthalic acid, 2-chloroterephthalic acid, 2-methylterephthalic acid, 5-methylisophthalic acid, 5-sodium sulfoisophthalic acid, hexahydroterephthalic acid, and hexahydroisophthalic acid; and alicyclic dicarboxylic acids such as 1,4-cyclohexanedicarboxylic acid, 1,3-cyclohexanedicarboxylic acid, 1,2-cyclohexanedicarboxylic acid, and 1,3-cyclopentanedicarboxylic acid. Two or more of these monomers may be copolymerized.

The polyamide resin (A) may have any degree of polymerization but preferably has a relative viscosity, as measured at 25° C. in a 98% concentrated sulfuric acid solution at a resin concentration of 0.01 g/ml, of 1.5 to 7.0. A relative viscosity of 1.5 or more leads to a moderately high viscosity of the polyamide resin composition, which can reduce air entrapment during molding to further improve the moldability. The relative viscosity is more preferably 1.8 or more. On the other hand, a relative viscosity of 7.0 or less leads to a moderately low viscosity of the polyamide resin composition, which can further improve the moldability.

The amount of terminal amino group of the polyamide resin (A) is preferably, but not necessarily, 1.0 to 10.0×10⁻⁵ mol/g. The amount of terminal amino group of 1.0 to 10.0×10⁻⁵ mol/g can provide a sufficient degree of polymerization and a molded article with improved mechanical strength. The amount of terminal amino group of the polyamide resin (A) can be determined by dissolving the polyamide resin (A) in a mixed solvent of phenol and ethanol (83.5:16.5 (volume ratio)) and titrating the resulting solution using a 0.02N aqueous hydrochloric acid solution.

The ethylene/α-olefin copolymer (B) is an ethylene/α-olefin copolymer modified with an unsaturated carboxylic acid and/or a derivative thereof. The derivative of an unsaturated carboxylic acid is an unsaturated carboxylic acid compound having a carboxyl group whose hydroxy moiety is substituted, and examples include metal salts, acid halides, esters, acid anhydrides, amides, and imides of unsaturated carboxylic acids.

Examples of unsaturated carboxylic acids and/or derivatives thereof include acrylic acid, methacrylic acid, maleic acid, fumaric acid, itaconic acid, crotonic acid, methyl maleic acid, methyl fumaric acid, mesaconic acid, citraconic acid, glutaconic acid, and metal salts of these carboxylic acids; unsaturated carboxylates such as methyl hydrogen maleate, methyl hydrogen itaconate, methyl acrylate, ethyl acrylate, butyl acrylate, 2-ethylhexyl acrylate, hydroxyethyl acrylate, methyl methacrylate, 2-ethylhexyl methacrylate, hydroxyethyl methacrylate, aminoethyl methacrylate, dimethyl maleate, and dimethyl itaconate; acid anhydrides such as maleic anhydride, itaconic anhydride, citraconic anhydride, endo-bicyclo-(2,2,1)-5-heptene-2,3-dicarboxylic acid, and endo-bicyclo-(2,2,1)-5-heptene-2,3-dicarboxylic anhydride; and maleimide, N-ethylmaleimide, N-butylmaleimide, N-phenylmaleimide, glycidyl acrylate, glycidyl methacrylate, glycidyl ethacrylate, glycidyl itaconate, glycidyl citraconate, and 5-norbornene-2,3-dicarboxylic acid. Of these, unsaturated dicarboxylic acids and acid anhydrides thereof are preferred, and maleic acid or maleic anhydride are particularly preferred.

The ethylene/α-olefin copolymer can be modified with these unsaturated carboxylic acids or derivatives thereof, for example, by copolymerization of an ethylene/α-olefin copolymer and an unsaturated carboxylic acid and/or a derivative thereof or by graft incorporation of an unsaturated carboxylic acid and/or a derivative thereof into an unmodified ethylene/α-olefin copolymer using a radical initiator.

Preferred ethylene/α-olefin copolymers are copolymers of ethylene and α-olefins of 3 to 20 carbon atoms. Specific examples of α-olefins of 3 to 20 carbon atoms include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene, and 12-ethyl-1-tetradecene. Two or more of these may be used. Of these α-olefins, α-olefins of 3 to 12 carbon atoms are preferred to improve mechanical strength. Furthermore, at least one of unconjugated dienes including 1,4-hexadiene, dicyclopentadiene, 2,5-norbornadiene, 5-ethylidenenorbornene, 5-ethyl-2,5-norbornadiene, and 5-(1′-propenyl)-2-norbornene may be copolymerized.

The α-olefin content of the ethylene/α-olefin copolymer is preferably 1 to 30 mol %, more preferably 2 to 25 mol %, still more preferably 3 to 20 mol %.

The ethylene/α-olefin copolymer (B) may have any hardness. However, to further improve the heat cycle resistance of a molded article made of a polyamide resin composition, the ethylene/α-olefin copolymer (B) preferably has a Shore A hardness determined according to ASTM D2240-05 of 90 A or less, more preferably 80 A or less.

The amounts of the polyamide resin (A) and the ethylene/α-olefin copolymer (B) in the polyamide resin composition are not especially limited, but it is preferable that the polyamide resin composition contains 5 to 100 parts by weight of the ethylene/α-olefin copolymer (B) per 100 parts by weight of the polyamide resin (A). Not less than 5 parts by weight of the ethylene/α-olefin copolymer (B) can further improve the flexibility and the heat cycle resistance of the molded article. On the other hand, not more than 100 parts by weight of the ethylene/α-olefin copolymer (B) can prevent failure points from occurring even if charging and discharging of higher-pressure hydrogen is repeated. The amount of the ethylene/α-olefin copolymer (B) is more preferably not more than 80 parts by weight, still more preferably not more than 70 parts by weight, most preferably not more than 50 parts by weight.

To the polyamide resin composition, other components than the components (A) and (B) may optionally be added to the extent that the properties of the composition are not impaired. Examples of other components include fillers, thermoplastic resins other than the component (A), impact modifiers other than the component (B), and various additives.

For example, adding a filler can provide a molded article with improved properties such as strength and dimensional stability. The shape of the filler may be fibrous or non-fibrous, and a fibrous filler and a non-fibrous filler may be used in combination. Examples of fibrous fillers include glass fibers, glass milled fibers, carbon fibers, potassium titanate whiskers, zinc oxide whiskers, aluminum borate whiskers, aramid fibers, alumina fibers, silicon carbide fibers, ceramic fibers, asbestos fibers, gypsum fibers, and metal fibers. Examples of non-fibrous fillers include silicates such as wollastonite, zeolite, sericite, kaolin, mica, clay, pyrophyllite, bentonite, asbestos, talc, and alumina silicate; metal oxides such as alumina, silicon oxide, magnesium oxide, zirconium oxide, titanium oxide, and iron oxide; metal carbonates such as calcium carbonate, magnesium carbonate, and dolomite; metal sulfates such as calcium sulfate and barium sulfate; metal hydroxides such as magnesium hydroxide, calcium hydroxide, and aluminum hydroxide; and glass beads, ceramic beads, boron nitride, and silicon carbide. These fillers may be hollow. These fibrous fillers and/or non-fibrous fillers are preferably pretreated with coupling agents before use to provide more excellent mechanical properties. Examples of coupling agents include isocyanate compounds, organic silane compounds, organic titanate compounds, organic borane compounds, and epoxy compounds.

Examples of thermoplastic resins include polyamide resins other than the component (A), polyester resins, polyphenylene sulfide resins, polyphenylene oxide resins, polycarbonate resins, polylactic resins, polyacetal resins, polysulfone resins, polytetrafluoroethylene resins, polyetherimide resins, polyamide-imide resins, polyimide resins, polyethersulfone resins, polyether ketone resins, polythioether ketone resins, polyether ether ketone resins, styrene resins such as polystyrene resins and ABS resins, and polyalkylene oxide resins. Two or more of these thermoplastic resins may be added. In addition, when a polyamide resin other than the component (A) is added, its amount is preferably not more than 4 parts by weight based on 100 parts by weight of the polyamide resin (A).

Examples of the impact modifier include olefin resins other than the component (B), acrylic rubber, silicone rubber, fluorine rubber, styrene rubber, nitrile rubber, vinyl rubber, urethane rubber, polyamide elastomers, polyester elastomers, and ionomers. Two or more of these may be added.

The impact modifier may be of any structure, for example, what is called a core-shell multilayer structure including at least one layer made of rubber and one or more layers made of polymers different from the rubber. The multilayer structure may be composed of two, three, or four or more layers and preferably has at least one inner rubber layer (core layer). Examples of the rubber constituting the rubber layer of the multilayer structure include, but are not limited to, rubbers obtained by polymerizing acrylic components, silicone components, styrene components, nitrile components, conjugated diene components, urethane components, ethylene components, propylene components, isobutene components, and other components. The different polymers constituting the layers other than the rubber layer of the multilayer structure may be any polymers having thermoplasticity and are preferably polymers having glass transition temperatures higher than that of the rubber layer. Examples of polymers having thermoplasticity include polymers containing unsaturated carboxylic acid alkyl ester units, unsaturated carboxylic acid units, unsaturated-glycidyl-containing units, unsaturated dicarboxylic anhydride units, aliphatic vinyl units, aromatic vinyl units, vinyl cyanide units, maleimide units, unsaturated dicarboxylic acid units, and other vinyl units.

Examples of various additives include anti-coloring agents, antioxidants such as hindered phenols and hindered amines, release agents such as ethylene bisstearyl amides and higher fatty acid esters, plasticizers, heat stabilizers, lubricants, ultraviolet absorbers, coloring agents, flame retardants, and blowing agents.

To the polyamide resin composition, copper compounds that can improve long-term heat resistance are preferably added together with the polyamide resin (A). Examples of copper compounds include cuprous chloride, cupric chloride, cuprous bromide, cupric bromide, cuprous iodide, cupric iodide, cupric sulfate, cupric nitrate, cupric phosphate, cuprous acetate, cupric acetate, cupric salicylate, cupric stearate, cupric benzoate, and complex compounds of these copper inorganic halides with, for example, xylylenediamine, 2-mercaptobenzimidazole, and benzimidazole. Two or more of these may be added. Of these, monovalent copper compounds, in particular, monohalogenated copper compounds are preferred, and, for example, cuprous acetate and cuprous iodide are preferred. The amount of copper compound is preferably 0.01 part by weight or more, more preferably 0.015 part by weight or more, based on 100 parts by weight of the polyamide resin (A). On the other hand, to prevent or reduce the coloring due to the release of metallic copper during molding, the amount of copper compound is preferably 2 parts by weight or less, more preferably 1 part by weight or less.

Together with the copper compounds, alkali halides may also be added. Examples of alkali halide compounds include lithium chloride, lithium bromide, lithium iodide, potassium chloride, potassium bromide, potassium iodide, sodium bromide, and sodium iodide. Two or more of these may be added. Potassium iodide and sodium iodide are particularly preferred.

A description will now be given of a method of preparing the polyamide resin composition. The thermoplastic polyamide resin composition can be prepared by any method such as kneading the polyamide resin (A), the ethylene/α-olefin copolymer (B) and, optionally, other components in a batch. Any known kneading device such as Banbury mixers, rolls, and extruders can be employed. Other components such as various additives, when added to the polyamide resin composition, can be added at any timing. For example, when the polyamide resin composition is prepared using a twin-screw extruder, other components may be added at the same time as the polyamide resin (A) and the ethylene/α-olefin copolymer (B) are added; other components may be added, for example, by side feeding when the polyamide resin (A) and the ethylene/α-olefin copolymer (B) are melt kneaded; other components may be added after the polyamide resin (A) and the ethylene/α-olefin copolymer (B) are melt kneaded; or other components may be added to the polyamide resin (A) and melt kneaded before the ethylene/α-olefin copolymer (B) is added.

The polyamide resin composition is suitable for use for a molded article exposed to high-pressure hydrogen. The molded article exposed to high-pressure hydrogen is a molded article exposed to hydrogen at a pressure above atmospheric pressure. Being less likely to suffer failure points despite repeated charging and discharging of high-pressure hydrogen, the molded article is used, preferably, as a molded article exposed to hydrogen at 20 MPa or higher, more preferably, as a molded article exposed to hydrogen at 30 MPa or higher. On the other hand, the molded article is used, preferably, as a molded article exposed to hydrogen at a 200 MPa or lower, more preferably, as a molded article exposed to hydrogen at 150 MPa or lower, still more preferably, as a molded article exposed to hydrogen at 100 MPa or lower.

The polyamide resin composition can be molded into molded articles by any method and the shape of molded articles can be an arbitrary shape. Examples of molding methods include extrusion molding, injection molding, hollow molding, calender molding, compression molding, vacuum molding, foam molding, blow molding, and rotational molding. The shape of molded articles may be, for example, pellet-like, plate-like, fibrous, strand-like, film- or sheet-like, pipe-like, hollow or box-like.

The molded article, for its excellent heat cycle resistance and unlikeliness to suffer failure points despite repeated charging and discharging of high-pressure hydrogen, is suitable for use for on-off valves for high-pressure hydrogen, check valves for high-pressure hydrogen, pressure-reducing valves for high-pressure hydrogen, pressure-regulating valves for high-pressure hydrogen, seals for high-pressure hydrogen, hoses for high-pressure hydrogen, tanks for high-pressure hydrogen, liners for high-pressure hydrogen, pipes for high-pressure hydrogen, packings for high-pressure hydrogen, pressure sensors for high-pressure hydrogen, pumps for high-pressure hydrogen, tubes for high-pressure hydrogen, regulators for high-pressure hydrogen, films for high-pressure hydrogen, sheets for high-pressure hydrogen, fibers for high-pressure hydrogen, joints for high-pressure hydrogen or the like.

Of these, the molded article, for its excellence in both flexibility and heat cycle resistance, is suitable for use for a hose for high-pressure hydrogen. The hose for high-pressure hydrogen is used as a hose for charging a fuel-cell vehicle or the like with hydrogen from a hydrogen station. Since the hose for high-pressure hydrogen is subject to repeated temperature changes (heat cycles) from −40° C. or lower to 90° C. or higher due to charging and discharging of high-pressure hydrogen, it is required to have high heat cycle resistance as well as flexibility.

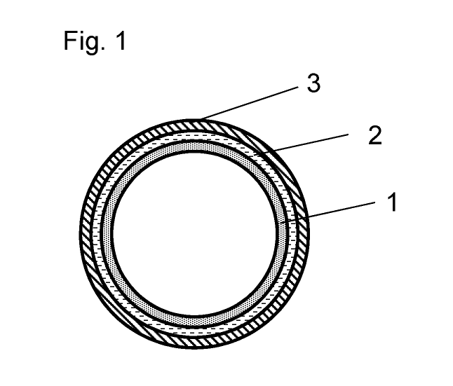

Preferred hose for high-pressure hydrogen is a hose having a reinforcement layer on the outside of an inner layer obtained by molding the polyamide resin composition into a tubular form. The pressure resistance of the hose is improved while maintaining the flexibility of the hose by providing the reinforcement layer on the outside. More preferred hose is a hose further having a weather-resistant layer as the outermost layer. Since the hydrogen station is often installed outdoors, the hose for high-pressure hydrogen can be prevented from being deteriorated by having the weather-resistant layer as the outermost layer. The cross section view of such hose is shown in FIG. 1. A reinforcement layer 2 is provided outside a tubular inner layer 1 made of the polyamide resin composition, and a weather-resistant layer 3 is further provided as the outermost layer.

In view of high pressure resistance and flexibility, an aramid fiber or a poly-p-phenylene benzbisoxazole fiber is preferred as the material of the reinforcement layer, and a poly-p-phenylene benzbisoxazole fiber is more preferred to further improve the pressure resistance. Preferably, the reinforcement layer is provided by concentrically coating around the inner layer with these fibers.

Examples of the material of the weather-resistant layer include aramid fibers, polyester fibers, polyamide fibers, aramid resins, polyester resins, and polyamide resins. Preferably, the reinforcement layer is provided by concentrically coating around the reinforcement layer with these resins.

### EXAMPLES

The effects will now be described in more detail with reference to examples. The examples below are not intended to limit this disclosure. Evaluations in Examples and Comparative Examples were conducted by the following methods.

### (1) Flexibility: Flexural Modulus

Using each of the pellets obtained in Examples and Comparative Examples, bending test pieces having a thickness of ⅛ inches and conforming to ASTM D-790 were injection molded with an “SE-75DUZ-C250” injection molding machine available from Sumitomo Heavy Industries, Ltd. under the following molding conditions: mold temperature, 80° C.; injection speed, 100 mm/sec; cooling time, 20 seconds. The temperature of the injection molding machine was set at 230° C.-235° C.-240° C.-240° C. from the downward part of the hopper to the tip part, in order.

The flexural moduluses of the molded articles obtained were evaluated according to ASTM D790:95 at 23° C. The flexural modulus was the average value obtained from three molded articles measured.

### (2) Heat Cycle Resistance

Each of the pellets obtained in Examples and Comparative Examples was overmolded at a thickness of 0.7 mm on a metal core of 48.6 mm×48.6 mm×28.6 mm using a “SE-75DUZ-C250” injection molding machine available from Sumitomo Heavy Industries, Ltd. under the following molding conditions: mold temperature, 80° C.; injection speed, 100 mm/sec; cooling time, 20 seconds. The temperature of the injection molding machine was set at 250° C.-255° C.-260° C.-260° C. from the downward part of the hopper to the tip part, in order.

Three of the metal/resin composite molded articles obtained were allowed to stand at −45° C. for one hour and then at 90° C. for one hour. The resulting composite molded articles were visually observed to check the presence of cracks. This cycle was repeated, and the number of cycles until all of the three composite molded articles were cracked was determined and evaluated as follows: 1500 cycles or more, A; 1200 to 1499 cycles, B; 1199 cycles or less, C.

### (3) Resistance to Repeated Charging and Discharging of High-Pressure Hydrogen

Using each of the pellets obtained in Examples and Comparative Examples, prismatic test pieces of 63.5 mm×12.6 mm×12.6 mm were injection molded with an “SG-75H-MIV” injection molding machine available from Sumitomo Heavy Industries, Ltd. under the following molding conditions: mold temperature, 80° C.; injection speed, 10 mm/sec; holding pressure, 10 MPa; pressure-holding time, 10 seconds; cooling time, 20 seconds. The temperature of the injection molding machine was set at 220° C.-225° C.-230° C.-230° C. from the downward part of the hopper to the tip part, in order.

The prismatic test pieces obtained of 63.5 mm×12.6 mm×12.6 mm were processed into the cubes of 5 mm×5 mm×5 mm by milling. The test pieces processed were subjected to X-ray CT analysis using “TDM1000-IS” available from Yamato Scientific Co., Ltd. to check the presence of failure points. A test piece having no failure point was placed in an autoclave, and then hydrogen gas was fed into the autoclave over five minutes to a pressure of 20 MPa. The pressure was held for 1 hours and then reduced to atmospheric pressure over five minutes. This cycle was repeated 100 times. The test piece after 100 cycles was subjected to X-ray CT analysis using “TDM1000-IS” available from Yamato Scientific Co., Ltd. to check the presence of failure points of 1 μm or larger. The test pieces having no failure points were evaluated as “Yes”, and the test pieces having failure points were evaluated as “No”.

Reference Example 1 Preparation of Polyamide 610 Resin (Polyamide Resin (A) Including Unit Derived from Hexamethylenediamine and Unit Derived from Aliphatic Dicarboxylic Acid of 8 to 12 Carbon Atoms)

An equimolar salt of hexamethylenediamine and sebacic acid was put into a polymerization can, and pure water of the same amount as the amount of the equimolar salt was added. Subsequently, N₂ substitution in the can was performed. The polymerization can was then heated with stirring to the final achieving temperature of 280° C. while controlling so that the maximum internal pressure of the can was 1.96 MPa for the reaction. The reactant was discharged into a water bath and pelletized with a strand cutter to give a pellet of a polyamide 610 resin. The pellet obtained had a relative viscosity of 3.5, as measured at 25° C. in a 98% concentrated sulfuric acid solution at a resin concentration of 0.01 g/ml. The amount of terminal amino group of the pellet obtained was 3.5×10⁻⁵ mol/g, as determined by dissolving in a mixed solvent of phenol and ethanol (83.5:16.5 (volume ratio)) and titrating the resulting solution using a 0.02N aqueous hydrochloric acid solution.

Materials used in Examples and Comparative Examples and abbreviations thereof are described below.

PA6: polyamide 6 resin (melting point: 224° C., cooling crystallization temperature: 175° C., relative viscosity determined at 25° C. in a 98% concentrated sulfuric acid solution at a resin concentration of 0.01 g/ml: 2.70)

PA11: polyamide 11 resin “RILSAN” (registered trademark) BESN TL (ARKEMA)

PA6/66: polyamide 6/66 resin “UBE NYLON” (registered trademark) 5034B (Ube Industries, Ltd.)

Impact modifier 1 (an ethylene/α-olefin copolymer (B) modified with an unsaturated carboxylic acid and/or a derivative thereof): maleic anhydride-modified ethylene/1-butene copolymer “TAFMER” (registered trademark) MH7020 (Mitsui Chemicals, Inc.) (Shore A hardness: 70 A)

Impact modifier 2: glycidyl methacrylate-modified polyethylene copolymer “BONDFAST” (registered trademark) 7L (Sumitomo Chemical Co., Ltd.) (Shore A hardness: 60 A)

### Examples 1 to 2 and Comparative Examples 1 to 3, 5, and 6

A twin-screw extruder (TEX30XSSST available from JSW) (L/D=45.5, wherein L is a distance from a feed port to a discharge port and D is a screw diameter) was set to a cylinder temperature of 240° C., a screw arrangement including two kneading zones, and a screw speed of 200 rpm. Raw materials shown in Table 1 were fed into the extruder and melt kneaded. A gut discharged through a die was rapidly cooled by being passed through a cooling bath filled with water conditioned at 5° C. over 20 seconds, and then pelletized with a strand cutter to give pellets. The pellets obtained were evaluated by the above-described methods. The results are shown in Table 1.

### Comparative Example 4

The pellet of the polyamide 11 resin “RILSAN” (registered trademark) BESN TL (ARKEMA) was evaluated by the above-described methods. The result is shown in Table 1.

TABLE 1

| | | | | | Comparative | Comparative | Comparative | Comparative | Comparative | Comparative |
|---|---|---|---|---|---|---|---|---|---|---|
| | | | Example 1 | Example 2 | Example 1 | Example 2 | Example 3 | Example 4 | Example 5 | Example 6 |
| Composition | PA610 | Parts by | 100 | 100 | 100 | 100 | — | — | — | — |
| | | weight | | | | | | | | |
| | PA6 | Parts by | — | — | — | — | 100 | — | 100 | 87.5 |
| | | weight | | | | | | | | |
| | PA11 | Parts by | — | — | — | — | — | 100 | — | — |
| | | weight | | | | | | | | |
| | PA6/66 | Parts by | — | — | — | — | — | — | — | 12.5 |
| | | weight | | | | | | | | |
| | Impact | Parts by | 11 | 43 | — | — | — | — | 11 | 11 |
| | modifier 1 | weight | | | | | | | | |
| | Impact | Parts by | — | — | 11 | — | — | — | — | — |
| | modifier 2 | weight | | | | | | | | |
| Kneading | Barrel setting | ° C. | 240 | 240 | 240 | 240 | 240 | — | 240 | 240 |
| condition | temperature | | | | | | | | | |
| Evaluation | Flexural | GPa | 1.45 | 1.03 | 1.60 | 2.19 | 2.71 | 1.29 | 2.28 | 1.79 |
| results | modulus | | | | | | | | | |
| | Heat cycle | — | A | A | B | C | C | C | C | C |
| | resistance | | | | | | | | | |
| | Failure point | — | No | No | No | No | No | Yes | No | Yes |

The results showed that a molded article made of a polyamide resin composition comprising a polyamide resin (A) including a unit derived from hexamethylenediamine and a unit derived from an aliphatic dicarboxylic acid of 8 to 12 carbon atoms and an ethylene/α-olefin copolymer (B) modified with an unsaturated carboxylic acid and/or a derivative thereof has excellent flexibility and heat cycle resistance and is less likely to suffer failure points despite repeated charging and discharging of high-pressure hydrogen.

### INDUSTRIAL APPLICABILITY

The polyamide resin composition can provide a molded article having excellent flexibility and heat cycle resistance and less likely to suffer failure points despite repeated charging and discharging of high-pressure hydrogen. Having these properties, the molded article made of the polyamide resin composition can be widely used as a molded article exposed to high-pressure hydrogen.

1.-6. (canceled)

7. A polyamide resin composition for a molded article exposed to high-pressure hydrogen comprising a polyamide resin (A) including a unit derived from hexamethylenediamine and a unit derived from an aliphatic dicarboxylic acid of 8 to 12 carbon atoms and an ethylene/α-olefin copolymer (B) modified with an unsaturated carboxylic acid and/or a derivative thereof.

8. The polyamide resin composition according to claim 7, comprising 100 parts by weight of the polyamide resin (A) including a unit derived from hexamethylenediamine and a unit derived from an aliphatic dicarboxylic acid of 8 to 12 carbon atoms and 5 to 100 parts by weight of the ethylene/α-olefin copolymer (B) modified with an unsaturated carboxylic acid and/or a derivative thereof.

9. A molded article exposed to high-pressure hydrogen comprising the polyamide resin composition according to claim 7.

10. A hose for high-pressure hydrogen exposed to high-pressure hydrogen comprising the polyamide resin composition according to claim 7.

11. A hose for high-pressure hydrogen comprising a reinforcement layer arranged exteriorly of an inner layer comprising the polyamide resin composition according to claim 7.

12. The hose according to claim 11, further comprising a weather-resistant layer as an outermost layer.

13. A molded article exposed to high-pressure hydrogen comprising the polyamide resin composition according to claim 8.

14. A hose for high-pressure hydrogen exposed to high-pressure hydrogen comprising the polyamide resin composition according to claim 8.

15. A hose for high-pressure hydrogen comprising a reinforcement layer arranged exteriorly of an inner layer comprising the polyamide resin composition according to claim 8.

16. The hose according to claim 15, further comprising a weather-resistant layer as an outermost layer.
